(19) United States
(12) Patent Application Publication
(10) Pub. No.: US 2022/0058024 A1
(43) Pub. Date: Feb. 24, 2022

(54) USING TAGGED INSTRUCTION EXTENSION TO EXPRESS DEPENDENCY FOR MEMORY-BASED ACCELERATOR INSTRUCTIONS

(71) Applicant: Alibaba Group Holding Limited, Georgetown (KY)

(72) Inventors: Yuanwei FANG, Sunnyvale, CA (US); Fei SUN, San Jose, CA (US); Fei XUE, Sunnyvale, CA (US); Yuejian XIE, Sunnyvale, CA (US); Yuhao WANG, Sunnyvale, CA (US); Yen-Kuang CHEN, Palo Alto, CA (US)

(21) Appl. No.: 16/996,710

(22) Filed: Aug. 18, 2020

(51) Int. Cl. G06F 9/38; G06F 9/30; G06F 8/41; G06F 8/71

(52) U.S. Cl. CPC G06F 9/3838; G06F 9/3877; G06F 8/71; G06F 9/30156; G06F 8/4452; G06F 9/3001

(57) ABSTRACT

A method of performing out-of-order execution in a processing system comprising a processing unit and one or more accelerators comprises dispatching a plurality of coarse-grained instructions, each instruction extended to comprise one or more tags, wherein each tag comprises dependency information for the respective instruction expressed at a coarse-grained level. The method also comprises translating the plurality of coarse-grained instructions into a plurality of fine-grained instructions, wherein the dependency information is translated into dependencies expressed at a fine-grained level. Further, the method comprises resolving the dependencies at the fine-grained level and scheduling the plurality of fine-grained instructions for execution across the one or more accelerators in the processing system.

### FIELD OF THE INVENTION

Embodiments according to the present invention relate to a method for enhancing the performance of programmable accelerators in processing systems.

### BACKGROUND OF THE INVENTION

In recent years, with the end of Moore's law in sight and with the advent of processors based on the RISC-V architecture, the focus of chip and device makers is on software programmable accelerators, e.g., artificial intelligence (AI) accelerators. For example, accelerators speed up processes such as artificial neural network (ANN) tasks, machine learning (ML) and machine vision. Accelerators free up the main processor or processor cores (in multi-core and many-core processors) from having to deal with complex chores that can be resource-intensive. Hardware acceleration has many advantages, the main one being speed. Accelerators can greatly decrease the amount of time it takes to conduct certain tasks, e.g., training and executing an AI model.

Typically, accelerators, for example, Tensor Processing Units (TPUs) and NVIDIA Deep Learning Accelerators (NVDLAs) do not use load-store architectures. Conventional load-store architectures comprise instruction set architectures that divide instructions into two categories, e.g., memory access (load and store between memory and registers) and Arithmetic Logic Unit (ALU) operations (which only occur between registers). Because certain accelerators do not use load-store architectures, accelerator software is complex to develop and it typically difficult to program accelerators so that they integrate seamlessly with the processor or processor cores (e.g., RISC-V processors that use load-store architectures). For example, when accelerators are integrated with a RISC-V core as co-processors (or functional units), in-order software pipelining (e.g., static scheduling) might not be sufficient to handle dynamic events (e.g., cache miss). Furthermore, accelerator instructions typically appear as intrinsics (e.g., functions that are built-in) in the software program, which prevents compiler optimization. Often, developers of accelerators need architectural support to simply software development for the accelerators. As a result, systems that can efficiently integrate accelerators with multi-core or other processors are the subject of considerable innovation.

### BRIEF SUMMARY OF THE INVENTION

Accordingly, a need exists for a test methodology that can address the problems with the systems described above. Using the beneficial aspects of the systems described, without their respective limitations, embodiments of the present invention provide novel solutions to address these problems.

Embodiments of the present invention provide a software and hardware system that supports extending the instruction set architecture for accelerators (e.g., accelerators comprising non load-store architectures) to use tags in each instruction to express dependencies. The tagged instruction extension and the hardware support for the extension allow a developer to program the accelerator in order to address dependencies in a program more efficiently. The hardware configured with the extended instruction architecture supports the scaling and optimization of the system.

Embodiments of the present invention enable out-of-order execution across accelerators that comprise non load-store architectures to unlock accelerator-level parallelism and ease software development. The explicit expression of accelerator instruction dependency allows the compiler, runtime, and hardware to work together to optimize dataflow execution across the instructions. Coarse-grained instructions can be broken into smaller instructions according to actual hardware configuration. This enables efficient use of multiple accelerators which have variable execution time per instruction. Further, software programmers are prevented from needing to be familiar with extensive details pertaining to the accelerators (e.g., cycles per operation), which simplifies software development.

In one embodiment, a method of performing out-of-order execution in a processing system comprising a processing unit and one or more accelerators is disclosed. The method comprises dispatching a plurality of coarse-grained instructions, each instruction extended to comprise one or more tags, wherein each tag comprises dependency information for the respective instruction expressed at a coarse-grained level. The method also comprises translating the plurality of coarse-grained instructions into a plurality of fine-grained instructions, wherein the dependency information is translated into dependencies expressed at a fine-grained level. Further, the method comprises resolving the dependencies at the fine-grained level and scheduling the plurality of fine-grained instructions for execution across the one or more accelerators in the processing system.

In another embodiment, a processing system for performing out-of-order execution using one or more accelerators is presented. The system comprises a processing device communicatively coupled with a memory and the one or more accelerators, wherein the processing device comprises a dispatch unit operable to dispatch a plurality of coarse-grained instructions, each instruction extended to comprise one or more tags, wherein each tag comprises dependency information for the respective instruction expressed at a coarse-grained level. The system also comprises at least one issue queue comprising issue logic circuitry, wherein the issue logic circuitry is configured to: a) receive the plurality of coarse-grained instructions from the dispatch unit; b) translate the plurality of coarse-grained instructions into a plurality of fine-grained instructions, wherein the dependency information is translated into dependencies expressed at a fine-grained level; and c) resolve the dependencies at the fine-grained level. Further, the system comprises a scheduler configured to schedule the plurality of fine-grained instructions for execution across the one or more accelerators in the processing system.

In yet another embodiment, an apparatus for performing out-of-order execution is disclosed. The apparatus comprises a plurality of accelerators communicatively coupled with a processing device and at least one issue queue operable to: a) receive a plurality of coarse-grained instructions dispatched from the processing device, each instruction extended to comprise one or more tags, wherein each tag comprises dependency information for the respective instruction expressed at a coarse-grained level; b) translate the plurality of coarse-grained instructions into a plurality of fine-grained instructions, wherein the dependency information is translated into dependencies expressed at a fine-grained level; and c) resolve the dependencies at the fine-grained level. The apparatus also comprises a scheduler configured to schedule the plurality of fine-grained instructions for execution across the plurality of accelerators.

The following detailed description together with the accompanying drawings will provide a better understanding of the nature and advantages of the present invention.

### BRIEF DESCRIPTION OF THE DRAWINGS

Embodiments of the present invention are illustrated by way of example, and not by way of limitation, in the figures of the accompanying drawings and in which like reference numerals refer to similar elements.

FIG. 1 illustrates the manner in which an instruction set architecture may be extended to express dependencies for memory-based accelerators in accordance with an embodiment of the present invention.

FIG. 2 illustrates the manner in which dependencies at the coarse-grain level are broken down into explicit and implicit dependencies at the fine-grain level in accordance with an embodiment of the present invention.

FIG. 3 is a block diagram that illustrates the high level architecture of a processing system comprising a CPU core enhanced by multiple accelerators in accordance with an embodiment of the present invention.

FIG. 4 depicts a flowchart illustrating an exemplary process for performing out-of-order execution in a processing system comprising a processing unit and one or more accelerators in accordance with an embodiment of the present invention.

In the figures, elements having the same designation have the same or similar function.

### DETAILED DESCRIPTION OF THE INVENTION

Reference will now be made in detail to embodiments, examples of which are illustrated in the accompanying drawings. While the embodiments will be described in conjunction with the drawings, it will be understood that they are not intended to limit the embodiments. On the contrary, the embodiments are intended to cover alternatives, modifications and equivalents. Furthermore, in the following detailed description, numerous specific details are set forth in order to provide a thorough understanding. However, it will be recognized by one of ordinary skill in the art that the embodiments may be practiced without these specific details. In other instances, well-known methods, procedures, components, and circuits have not been described in detail as not to unnecessarily obscure aspects of the embodiments.

### NOTATION AND NOMENCLATURE SECTION

Some regions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing the terms such as “receiving,” “dispatching,” “translating,” “resolving,” and “scheduling” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The description below provides a discussion of computers and other devices that may include one or more modules. As used herein, the term “module” or “block” may be understood to refer to software, firmware, hardware, and/or various combinations thereof. It is noted that the blocks and modules are exemplary. The blocks or modules may be combined, integrated, separated, and/or duplicated to support various applications. Also, a function described herein as being performed at a particular module or block may be performed at one or more other modules or blocks and/or by one or more other devices instead of or in addition to the function performed at the described particular module or block. Further, the modules or blocks may be implemented across multiple devices and/or other components local or remote to one another. Additionally, the modules or blocks may be moved from one device and added to another device, and/or may be included in both devices. Any software implementations of the present invention may be tangibly embodied in one or more storage media, such as, for example, a memory device, a floppy disk, a compact disk (CD), a digital versatile disk (DVD), or other devices that may store computer code.

The terminology used herein is for the purpose of describing particular embodiments only and is not intended to limit the scope of the present invention. As used throughout this disclosure, the singular forms “a,” “an,” and “the” include plural reference unless the context clearly dictates otherwise. Thus, for example, a reference to “a module” includes a plurality of such modules, as well as a single module, and equivalents thereof known to those skilled in the art.

Using Tagged Instruction Extension to Express Dependency for Memory-Based Accelerator Instructions

Embodiments of the present invention provide a software and hardware system that supports extending the instruction set architecture for accelerators (e.g., accelerators comprising non load-store architectures) to use tags in each instruction to express dependencies. The tagged instruction extension and the hardware support for the extension allow a developer to program the accelerator in order to address dependencies in a program more efficiently. The hardware configured with the extended instruction architecture supports the scaling and optimization of the system.

Embodiments of the present invention enable out-of-order execution across accelerators that comprise non load-store architectures to unlock accelerator-level parallelism and ease software development. The explicit expression of accelerator instruction dependency allows the compiler, runtime, and hardware to work together to optimize dataflow execution across the instructions. Coarse-grained instructions can be broken into smaller instructions according to actual hardware configuration. This enables efficient use of multiple accelerators which have variable execution time per instruction. Further, software programmers are prevented from needing to be familiar with extensive details pertaining to the accelerators (e.g., cycles per operation), which simplifies software development.

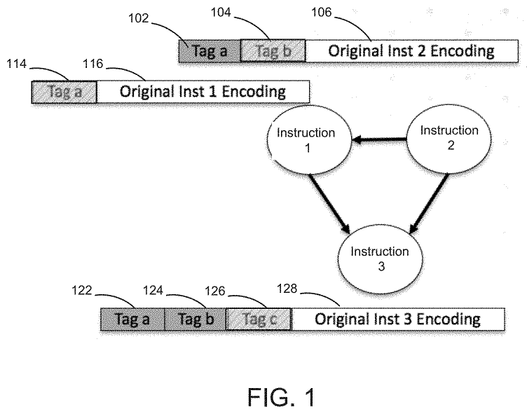

FIG. 1 illustrates the manner in which an instruction set architecture may be extended to express dependencies for memory-based accelerators in accordance with an embodiment of the present invention. In one embodiment, an instruction set architecture for non load-store accelerators (e.g., register memory architectures) may be extended using tags. Each instruction in the architecture may comprise one or more tags. At least one of the tags in each instruction may identify the respective source instruction itself (a self-identifying tag) while each additional tag may identify one or more instruction that the instruction depends on. In other words, an instruction (the source instruction) comprises at least one tag comprising an identifier (ID) used to identify the source instruction itself and, further, the instruction may comprise one or more additional tags comprising identifiers for instructions (the destination instructions) that the source instruction depends on.

For example, as seen in FIG. 1, instruction 3 depends on both instruction 1 and instruction 2. Instruction 2 depends only on instruction 1. And, finally, instruction 1 does not depend on any other instructions. As mentioned above, an instruction extended in accordance with an embodiment of the present invention comprises at least one tag to identify itself. For example, instruction 3 will be extended to comprise a total of three tags, 122, 124 and 126 in addition to the original encoding for instruction 3 128. Tag c 126 is the source tag that identifies instruction 3. Meanwhile tag a 122 and tag b 124 are destination tags that identify the instructions that instruction 3 depends on. For example, tag a 122 may identify instruction 1 while tag b 124 identifies instruction 2.

Similarly, instruction 2 comprises two tags in addition to the original encoding for instruction 2 106. Tag b 104 is the self-identifying source tag that identifies instruction 2. Tag a 102, meanwhile, identifies instruction 1 on which instruction 2 depends. Instruction 1, on the other hand, only comprises a single tag in addition to the original encoding for instruction 1 116. Tag a 114 comprises the self-identifying tag for instruction 1.

If there are encoding constraints such as a maximum number of tag bits that can be added to extend each instruction, in one embodiment, hardware configured in accordance with embodiments of the present invention may rename tags to eliminate tag bit encoding constraints within the instruction. For example, there may be an encoding constraint that restricts the extension to each instruction to a predetermined maximum number of bits. If an instruction has more dependencies than there are extension bits to encode the dependencies, the hardware can rename the tags to encode all the information as necessary. By way of example, if the software architecture only supports 16 bits of extension, but the underlying hardware can support 32 bits, the hardware can translate the 16 bits into 32 bits, rename them and keep track of this mapping. When new tags needed to be added to an instruction, the hardware automatically translates the tags to the hardware-mapped tags. In this way the hardware addresses the encoding constraints by renaming tags.

Instruction dependencies can be specified at multiple levels. At higher levels, more coarse-grained instructions are specified. Accordingly, dependencies are specified at the level of coarse-grained instructions. A software developer may, for example, develop a program that specifies dependencies at the coarse-grain level. Resolving dependencies at higher levels, however, may be costly. Accordingly, hardware configured in accordance with embodiments of the present invention may employ some dependency evaluation mechanisms that are more efficient. For example, instead of executing coarse-grained instructions immediately, several coarse-grained instructions are accumulated and transformed or translated into lower-level operations.

Further, the dependencies for the high-level operations are dynamically and automatically constructed at a lower level. In other words, the coarse-grained instructions are broken down into finer grained instructions and the dependencies are translated into dependencies at the level of the fine-grained instructions. The conversion into lower level instructions is handled by the hardware and is typically transparent from the perspective of the software developer. In other words, the software developer typically specifies the higher level operations using tag-extended instructions in accordance with embodiments of the present invention. In an embodiment of the present invention, the hardware then transforms the higher level instructions (written using the tag-extended instruction set architecture) into lower level operations and may construct the tag extensions to indicate dependencies at the level of the fine-grained instructions.

In one embodiment, after the instructions are broken down, explicit dependencies between the fine-grained instructions are determined by the compiler or the hardware. Explicit dependencies refer to pre-determined or pre-defined ways in which dependencies are established after instruction breakdown. On the other hand, implicit dependencies mean that the dependency establishment requires the software programmer's intervention after instruction breakdown. In the case of implicit dependencies then, the dependencies would be established by the software or firmware runtime. Typically, however, most coarse-grained instructions and the associated dependencies will be broken down into fine-grained instructions with associated explicit dependencies by the hardware. However, in cases where higher-level dependencies cannot be translated into explicit dependencies at the lower level, user intervention may be solicited as a fallback mechanism to receive further information regarding addressing the implicit dependencies.

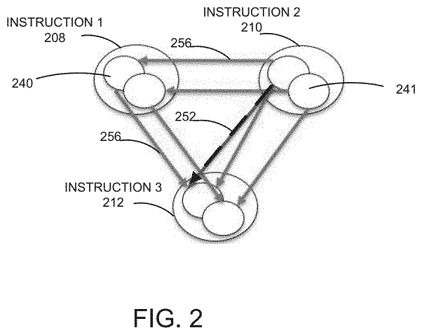

FIG. 2 illustrates the manner in which dependencies at the coarse-grain level are broken down into explicit and implicit dependencies at the fine-grain level in accordance with an embodiment of the present invention. As explained in connection with FIG. 1, instruction 3 212 depends on instruction 1 208 and instruction 2 210. Instruction 2 210, on the other hand, depends on instruction 1 208. The three instructions 208, 210 and 212 are coarse-grained instructions with dependencies that are expressed at the coarse-grained level using tag-extended instructions by the software developer. These coarse-grained tag-extended instructions may be broken down by the hardware into fine-grained instructions, e.g., instructions 240, 241, etc.

As noted above, explicit dependencies between the fine-grained instructions, e.g., dependencies 256 are determined by the compiler or the hardware. On the other hand, implicit dependencies, e.g., dependency 252 imply that the dependency establishment requires the software programmer's intervention after instruction breakdown. Accordingly, for dependency 252, the dependency would be established by the software or firmware runtime and may require explicit feedback from the software developer. In other words, more information may be required from the developer in order to resolve dependency 252.

In one embodiment, the breakdown of the coarse-grained instructions into fine-grained instructions can be static. The static breakdown of higher level instructions into lower level instructions happens prior to execution, e.g., during compilation time by the compiler. In an alternative embodiment, however, the breakdown of the coarse-grained instructions into fine-grained instructions can be dynamic. In other words, the firmware or hardware can perform the breakdown during runtime. The instructions can be translated during execution. Whether a static of a dynamic breakdown of instructions is chosen depends not only on the instruction tags (e.g., the extended instruction tags) but also on the functionality of the multiple instructions with which the tags are associated.

The dependencies of the instructions at the coarse grain level are explicitly expressed in the instruction semantic (e.g., execute an instruction until command X is encountered). Instructions can have explicitly dependencies encoded. These explicitly encoded dependencies may form a sub-dependency graph, apart from the original dependency graph. In an embodiment of the present invention, once the coarse-grained instructions are converted into fine-grained instructions, all these dependency graphs get merged into one after the instructions have been transformed into the low-level instructions.

In one embodiment, a memory barrier or fence instruction may be used by a software developer to implement explicit synchronization for instructions with a designated tag ID. For example, referring to the example of FIG. 1, a software developer may use a fence instruction to ensure that instruction 1 with tag a 114 is complete before either of the other two instructions (instructions 2 and 3) that depend on instruction 1 are executed. This allows the software developer to explicitly control synchronization of the instructions.

A memory barrier, also known as a membar, memory fence or fence instruction, is a type of barrier instruction that causes a central processing unit (CPU) or compiler to enforce an ordering constraint on memory operations issued before and after the barrier instruction. This typically means that operations issued prior to the barrier are guaranteed to be performed before operations issued after the barrier. Memory barriers are necessary because the accelerators combined with the processor cores of the present invention employ performance optimizations that can result in out-of-order execution.

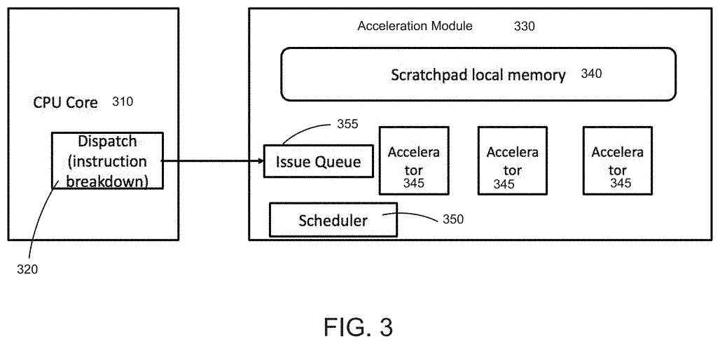

FIG. 3 is a block diagram that illustrates the high level architecture of a processing system comprising a CPU core enhanced by multiple accelerators in accordance with an embodiment of the present invention. The system comprises a CPU core 310 that comprises a dispatch unit 320. The dispatch unit 320 dispatches the tag extended instructions to the accelerator issue queue 355 within the acceleration module 330. Note that the dispatch unit 320 is not the same as a conventional dispatch unit associated with a processor core. Dispatch unit 320 is a modified dispatch unit that accommodates the tag extended instruction set in accordance with embodiments of the present invention. In one embodiment, the dispatch unit 320 can have runtime instruction breakdown support.

The acceleration module 330 comprises one or more accelerators 345, an issue queue 355, a scratchpad local memory 340 and a scheduler 350. The accelerators 345 are controlled by the tag-extended instructions and each accelerator may be equipped with its own issue queue or share a common issue queue 355 that stores dispatched tagged instructions. The issue queue 355 receives the coarse-grained tag extended instructions from the dispatch unit 320 and translates them into fine-grained instructions. The dependencies will typically get resolved within the issue queue. Once the dependencies are resolved, the scheduler 350 then processes the fine-grained instructions and executes them across the one or more accelerators 345. The scheduler 350 also monitors the matching of tags in the issue queue(s) and makes instruction issue decisions to the respective accelerator. For example, referring to the example of FIG. 1, if the scheduler wants to issue instruction 3, it will make sure to check Tag a 122 and Tag b 124 and ensure that the instructions associated with those tags have issued first.

Embodiments of the present invention are therefore able to advantageously enable out-of-order execution across accelerators that comprise non load-store architectures (e.g., register memory architectures). Note that a single processor (e.g., a single core, a multi-core or a many-core processor) may be communicatively coupled with one or more accelerators and the processor may use a conventional load-store architecture. Embodiments of the present invention advantageously unlock accelerator-level parallelism so that the accelerators and the processor can run in parallel at the same time and the accelerators are able to execute instructions out of order in parallel (by keeping track of the various dependencies).

Embodiments of the present invention also enable efficient use of multiple accelerators. For example, the tagged instruction extension allows data flow execution across accelerators. In other words, because the accelerators can process instructions out-of-order, the scheduling of operations is dependent exclusively on data availability (rather than being dependent on a sequence control structure to which processors are typically limited). Further, the hardware (including the accelerators) uses the tag extensions for the accelerator instruction architecture to determine when to schedule the instructions and launch the respective tasks in order to preserve dependencies. Accordingly, embodiments of the present invention can optimize performance through scheduling to tolerate the variable execution time per instruction between accelerators.

Further, embodiments of the present invention ease software development for a developer by facilitating a higher level of abstraction. Software development is simplified because the software programmers do not need to know the low-level details regarding the accelerators (e.g., cycles per operation) in order to develop software for the system.

Embodiments of the present invention also ease software portability on successive hardware generations by decoupling the software from the hardware through layers of abstraction. Accordingly, even though micro-architectures may change (e.g., the number of ALUs, number of processing units, memory bandwidth), embodiments of the present invention prevent a developer from needing to modify the code scheduling in software because tasks associated with the code scheduling will be offloaded onto the hardware.

Embodiments of the present invention provide superior results over existing CPU/GPU configurations which use register IDs to express dependencies across producers and consumers (instead of tag-based extensions to the instructions). The instructions in the CPU/GPU architectures are fine-grained compared to accelerator instructions and do not use hierarchical tag instruction extensions. Accordingly, CPU/GPU instructions are far less efficient compared to accelerator instructions on important compute-intensive kernels.

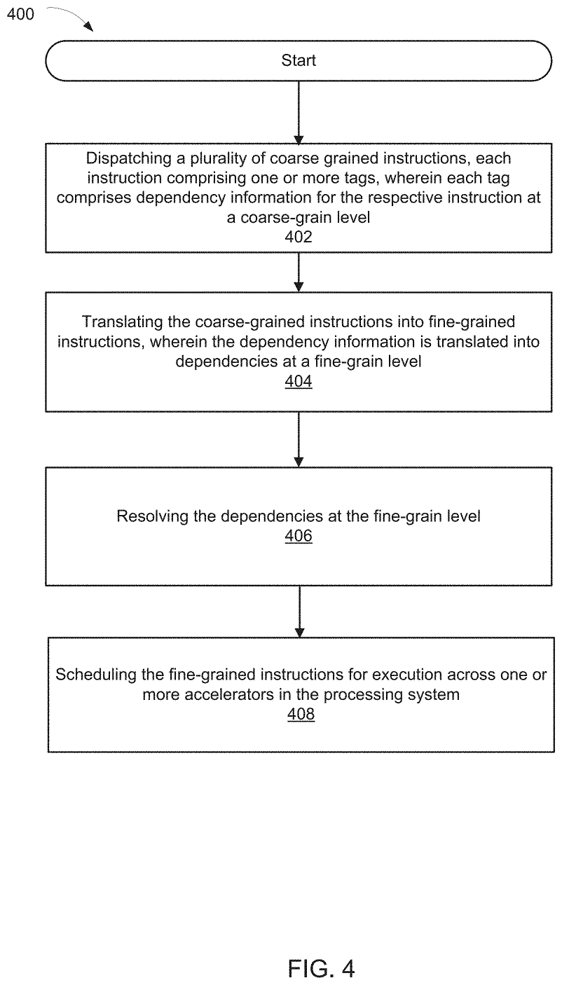

FIG. 4 depicts a flowchart 400 illustrating an exemplary process for performing out-of-order execution in a processing system comprising a processing unit and one or more accelerators in accordance with an embodiment of the present invention.

At block 402, a plurality of coarse-grained instructions are dispatched (e.g. from a dispatch unit of a processor), wherein each instruction is extended to comprise one or more tags, where each tag comprises dependency information for the respective instruction expressed at a coarse grain level. At least one tag in an instruction would comprise an identifier to self-identify the respective instruction. The instruction may also comprise one or more other tags, wherein each tag comprises an identifier to a different instruction that the respective instruction depends on.

At block 404, the coarse-grained are translated into fine-grained instructions (e.g., in an issue queue of the acceleration module 330), wherein the dependency information from the tags is translated into dependencies at the level of the fine-grained instructions.

At block 406, the dependencies at the fine-grained level are resolved.

Finally, at block 408, the scheduler 350 schedules the fine-grained instructions for execution across one or more accelerators of the processing system.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

What is claimed is:

1. A method of performing out-of-order execution in a processing system comprising a processing unit and one or more accelerators, the method comprising:
dispatching a plurality of coarse-grained instructions, each instruction extended to comprise one or more tags, wherein each tag comprises dependency information for a respective instruction expressed at a coarse-grained level;
translating the plurality of coarse-grained instructions into a plurality of fine-grained instructions, wherein the dependency information is translated into dependencies expressed at a fine-grained level;
resolving the dependencies at the fine-grained level; and
scheduling the plurality of fine-grained instructions for execution across the one or more accelerators in the processing system.

2. The method of claim 1, wherein the processing unit comprises a processor with a plurality of cores.

3. The method of claim 1, wherein the one or more tags in each instruction comprise at least one tag that comprises an identifier for the respective instruction.

4. The method of claim 1, wherein the one or more tags in each instruction comprise at least one tag that comprises an identifier for an instruction on which the respective instruction depends.

5. The method of claim 1, further comprising:
renaming the one or more tags at a hardware level of the processing system to eliminate tag bit encoding constraints.

6. The method of claim 1, wherein the dependency information comprises explicit dependencies, wherein the explicit dependencies are resolved by a compiler or at a hardware level of the processing system.

7. The method of claim 1, wherein the dependency information comprises implicit dependencies, and wherein the implicit dependencies are determined by software or by firmware runtime.

8. The method of claim 1, wherein the dependency information comprises implicit dependencies, wherein user intervention is required to resolve the implicit dependencies.

9. The method of claim 1, wherein at least one of the plurality of coarse-grained instructions comprises a fence instruction, wherein the fence instruction implements explicit synchronization for an associated instruction with a designated tag identifier.

10. A processing system for performing out-of-order execution using one or more accelerators, the system comprising:
a processing device communicatively coupled with a memory and the one or more accelerators, wherein the processing device comprises a dispatch unit operable to dispatch a plurality of coarse-grained instructions, each instruction extended to comprise one or more tags, wherein each tag comprises dependency information for a respective instruction expressed at a coarse-grained level;
at least one issue queue comprising issue logic circuitry, wherein the issue logic circuitry is configured to:
receive the plurality of coarse-grained instructions from the dispatch unit;
translate the plurality of coarse-grained instructions into a plurality of fine-grained instructions, wherein the dependency information is translated into dependencies expressed at a fine-grained level; and
resolve the dependencies at the fine-grained level; and
a scheduler configured to schedule the plurality of fine-grained instructions for execution across the one or more accelerators in the processing system.

11. The processing system of claim 10, wherein the processing device comprises a processor with a plurality of cores.

12. The processing system of claim 10, wherein the one or more tags in each instruction comprise at least one tag that comprises an identifier for the respective instruction.

13. The processing system of claim 10, wherein the one or more tags in each instruction comprise at least one tag that comprises an identifier for an instruction on which the respective instruction depends.

14. The processing system of claim 10, wherein the dependency information comprises explicit dependencies, and wherein the explicit dependencies are resolved by a compiler or at a hardware level of the processing system.

15. The processing system of claim 10, wherein the dependency information comprises implicit dependencies, wherein user intervention is required to resolve the implicit dependencies.

16. An apparatus for performing out-of-order execution, the apparatus comprising:
a plurality of accelerators communicatively coupled with a processing device;
at least one issue queue operable to:
receive a plurality of coarse-grained instructions dispatched from the processing device, each instruction extended to comprise one or more tags, wherein each tag comprises dependency information for a respective instruction expressed at a coarse-grained level;
translate the plurality of coarse-grained instructions into a plurality of fine-grained instructions, wherein the dependency information is translated into dependencies expressed at a fine-grained level; and
resolve the dependencies at the fine-grained level; and
a scheduler configured to schedule the plurality of fine-grained instructions for execution across the plurality of accelerators.

17. The apparatus of claim 16, wherein the processing device comprises a processor with a plurality of cores.

18. The apparatus of claim 16, wherein the one or more tags in each instruction comprise at least one tag that comprises an identifier for the respective instruction.

19. The apparatus of claim 16, wherein the one or more tags in each instruction comprise at least one tag that comprises an identifier for an instruction on which the respective instruction depends.

20. The apparatus of claim 16, wherein the at least one issue queue is configured to receive the plurality of coarse-grained instructions dispatched from a dispatch unit of the processing device.
